(19) United States
(12) Patent Application Publication
(10) Pub. No.: US 2020/0322285 A1
(43) Pub. Date: Oct. 8, 2020

(54) OPTIMIZING FAULT TOLERANCE ON EXASCALE ARCHITECTURE

(71) Applicants: Olivier Franza, BROOKLINE, WA (US); Farah Fargo, HUDSON, MA (US); David Lisandro Romero Antequera, ZAPOPAN (MX)

(72) Inventors: Olivier Franza, BROOKLINE, WA (US); Farah Fargo, HUDSON, MA (US); David Lisandro Romero Antequera, ZAPOPAN (MX)

(21) Appl. No.: 16/895,285

(22) Filed: Jun. 8, 2020

(51) Int. Cl. H04L 12/915; H04L 12/911; H04L 29/08; H04L 12/24

(52) U.S. Cl. CPC H04L 47/787; H04L 47/822; H04L 41/0896; H04L 41/0893; H04L 41/0809; H04L 67/1036

(57) ABSTRACT

Methods and apparatus for optimizing fault tolerance on HPC (high-performance computing) systems including systems employing exascale architectures. The method and apparatus implement one or more management/service nodes in a management/service node layer and a plurality of sub-management nodes in a sub-management node layer. The sub-management nodes implement redundant cross-connected software components in different sub-layers to provide redundant channels. The redundant software components in a lowest sub-layer are connected to switches in racks containing multiple service nodes. The sub-management nodes are configured to employ the multiple redundant channels to collect telemetry data and other data from the service nodes such that the system continues to collect the data in the event of a failure in a software component or hardware failure.

### BACKGROUND INFORMATION

High-performance computing (HPC) systems comprise thousands of nodes with a relatively small pool of service nodes used for the administration, monitoring and control of the rest of the system. Such HPC control and/or management facilities provide the point of control and service for administrators and operation staff who configure, manage, track, tune, interpret and service the system to maximize availability of resource for the applications. These facilities provide a comprehensive system view to understand the state of the HPC system under triaging capabilities, features history, and for organizing operations that keep the system operational. These HPC control/management facilities also support the system lifecycle from system design, to bring up, system standup, production, to lessons learned for the next generation. For a large HPC system, several problems may arise during the execution of the system in the compute service or management/service node, such as system power failures or communication link down, faults, errors, or failures, bit errors, packet loss during communication, etc. Current HPC control/management architectures do not adequately address these problems.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram of a UCS architecture, according to one embodiment;

FIG. 1a shows a scalable implementation of the UCS architecture of FIG. 1

FIG. 2 is a schematic diagram of an UCS architecture further supporting an out-of-band (OOB) mechanisms for collecting telemetry data, according to one embodiment;

FIG. 3 is a schematic diagram of a UCS architecture that employs a single stack of software components per sub-management node that are cross-connected across pairs of sub-management nodes;

FIG. 3a shows a failure of a UAS metrics unit and how it is handled in UCS architecture of FIG. 3;

FIG. 3b shows a failure of a UAS broker and how it is handled in UCS architecture of FIG. 3;

FIG. 3c shows a failure of a sensys-ng module and how it is handled in UCS architecture of FIG. 3

FIG. 4 is a schematic diagram of a physical rack architecture that may be used in and HPC or exascale system;

FIG. 5 is a diagram of a system that may be implemented for the management/service node, sub-management nodes and/or service nodes discussed and illustrated herein.

### DETAILED DESCRIPTION

Embodiments of methods and apparatus for optimizing fault tolerance on HPC systems including systems employing exascale architectures are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

To address resiliency problems that are not adequately handled by current HPC control/management architectures, a resilient architecture to enhance the system integrity and availability and making the system recover from any failures or difficulties on runtime is needed. Embodiments herein provide solutions for addressing these and other problems by employing redundancy (informative redundancy, time redundancy, software redundancy, hardware redundancy) and autonomic management to support dynamic decisions. The embodiments provide a unified approach using multiple redundant channels to collect the data from a single physical machine. In addition, a novel census voting scheme is implemented for making decisions that eliminates the need for a singlet trusted domain.

In accordance with some aspects of the novel unified HPC control/management architectures, resiliency and redundancy is applied to the sub-management nodes and the management/service node to enable the system to recover from failures or slowness in retrieving data from the service nodes such as software bugs, or random hardware faults, power off, forceful reboot, or memory bit “stuck”, and omission or commission fault in data transfer. The unified control/management architectures are also scalable to support implementation in exascale architectures.

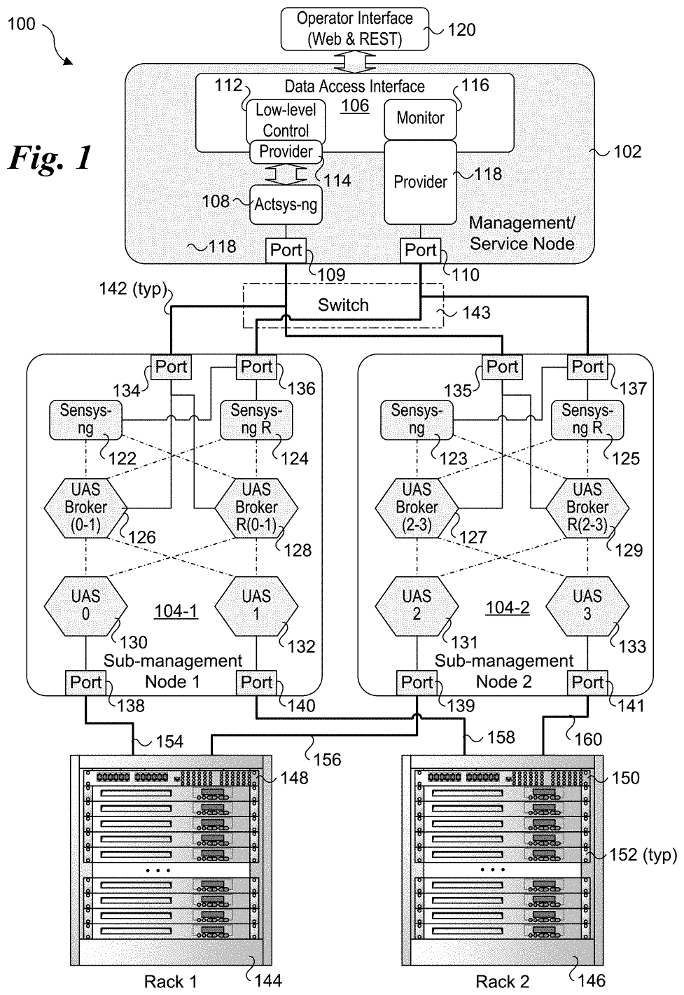

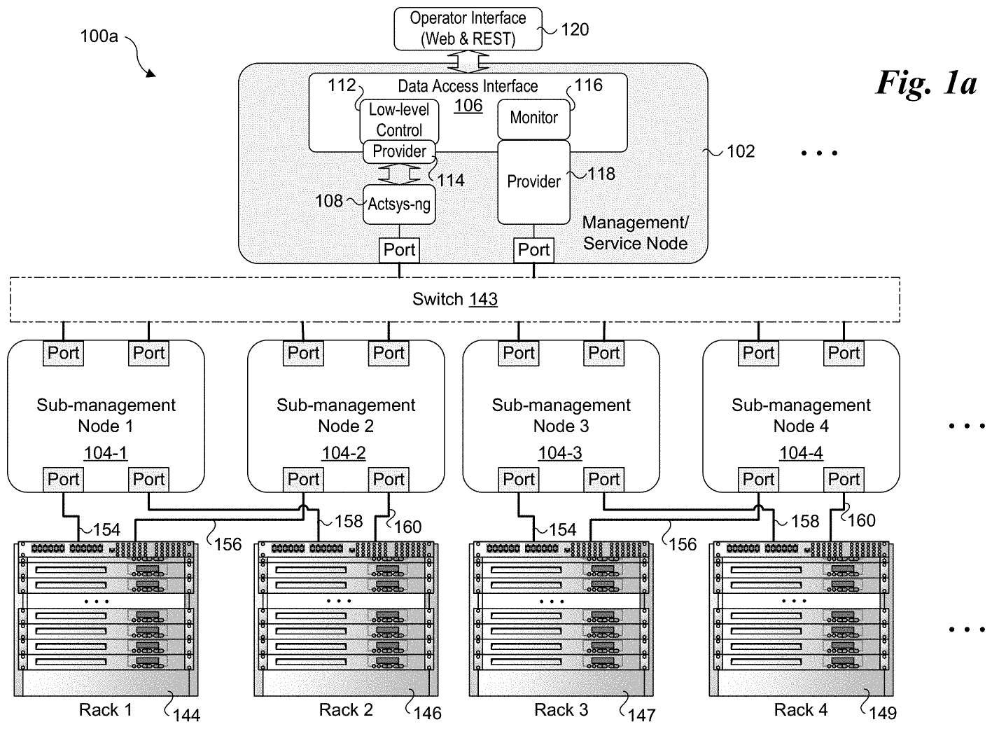

FIG. 1 shows a first embodiment of a Unified Control System (UCS) architecture 100 that may be implemented for HPC systems including large exascale systems. UCS architecture 100 is composed of three layers, including a management layer having one or more management/service nodes 102 (only one of which is shown), a sub-management layer including a plurality of sub-management nodes 104, and a service node layer including multiple racks of service nodes (also referred to as compute nodes). (The term “rack” is used herein to generically describe physical structures in which service and compute nodes are installed—these physical structures include but are not limited to racks and cabinets and they like). In one embodiment, a management/service node is implemented on a single physical machine, such as a service node or separate machine. Similarly, in one embodiment, a sub-management node is likewise implemented on a single physical machine, such as a service node in one of the racks or a separate machine. When implemented on a service node, a sub-management node may be referred to as a sub-management/service node but for simplicity such nodes are simply referred to as sub-management nodes in the text and drawings.

Management/service node 102 includes a data access interface 106, an actsys-ng (next generation) module 108, and a pair of ports 109 and 110. Communication between data access interface 106 and actsys-ng module 108 is supported via a low-level control 112 and a provider 114. Communication between data access interface 106 and sensys-ng (next generation) modules in sub-management nodes is implemented via a monitor 116 and a provider 118. In one embodiment, an operator interface 120 is provided to support communication with management/service node 102 that employs one or more Web services or micro-services using REST (aka a RESTful interface).

The sub-management nodes 104 (104-1 and 104-2) comprise sets of redundant components and modules, wherein the inclusion of an ‘R’ in the figures herein indicate a component or module is redundant. For example, sub-management node 104-1 includes a sensys-ng module 122 and a redundant sensys-ng module (Sensys-ng R) 124 that reside in a top sub-layer. (It is noted there are two instances of the sensys-ng module with one arbitrarily being depicted as the redundant instance in the figures herein.) The middle sub-layer includes two Unified Actors and Sensors (UAS) brokers 126 and 128. The bottom sub-layer of sub-management node 104-1 includes two UAS metrics units 130 and 132, also labeled UAS 0 and UAS 1. A sub-management node may generally include two or more ports, as depicted for illustrative purposes by ports 134, 136, 138, and 140 for sub-management node 104-1. It is noted that two or more of the ports illustrated in the figures herein may actually be implemented as a single port; the use of multiple instances of that port are used in the figures to simplify and clarify the connection architecture.

Sub-management node 104-2 has a similar configuration to sub-management node 104-1. Its components include a sensys-ng module 123 and a redundant sensys-ng module (Sensys-ng R) 125 that reside in the top sub-layer. The middle sub-layer includes two UAS brokers 127 and 129, and the bottom sub-layer of sub-management node 104-2 includes two UAS metrics units 135, and 137, also labeled UAS 2, and UAS 3. Sub-management node includes ports 135, 137, 139, and 141.

In the figures herein, the bold lines connected between ports represent physical communication links, as illustrated by a communication link 142 between port 134 and port 109. Depending on the connection endpoints, links between two nodes will generally traverse one or more switches, such as depicted by a switch 143 shown in phantom outline. Links between nodes and ToR switches may be direct links (e.g., use a single physical cable) or may use one or more switches (such as a switch card). For simplicity and clarity, such links may be shown without switches; however, it will be understood by those skilled in the art that switches may or may not be used, depending on the particular rack architecture and the connection endpoints.

Under UCS architecture 100, each sub-management node 104-1 and 104-2 is connected to a pair of racks 144 and 146 (also labeled Rack 1 and Rack 2). Racks 144 and 146 are generic representations of racks in an HPC or exascale system and may have various configurations and components and employ various types of rack architectures. For illustrative purposes, racks 144 and 146 are depicted as including a respective Top of Rack (ToR) switch 148 and 150, and a plurality of service nodes 152. In practice, a rack may include one or more switches that may or may not be located at the top of the rack; however, it is convention to refer to such switches as ToR switches whether or not they are located at the top of a rack. For simplicity and for illustrative purposes, service nodes 152 are depicted as 1U servers; in practice the service nodes described and illustrated herein may comprise various types of compute platforms, such as but not limited to single-socket servers, multi-socket servers, blade servers, server modules and accelerators having various form factors.

ToR switch 148 is communicatively-coupled to service nodes 152 in rack 144, while ToR switch 150 is communicatively-coupled to service nodes 152 in rack 146. Generally, one or more communication links may be employed for communication between a ToR switch and a chassis, drawer, or equivalent in which one or more service nodes are installed. For example, in the case of a service node comprising a blade server, there (generally) may be one or more communication links between a blade server chassis or drawer in which the blade server is installed and the ToR switch, with communication between blade servers installed in the blade server chassis facilitated by a backplane, midplane, base plane and the like. The blade server chassis may also include another layer of switch functionality (such as facilitated using one or more switch cards), enabling multiple blade servers to communicate with a ToR switch using one or more links (one link per switch card) between the ToR switch and the blade server chassis. Optionally, multiple links may be used, as well as combinations of in-band and out-of-band links. This is similar for server modules, which are installed in a server module chassis or drawer. Support for disaggregated architectures, such as Intel® Rack Space Design may also be supported.

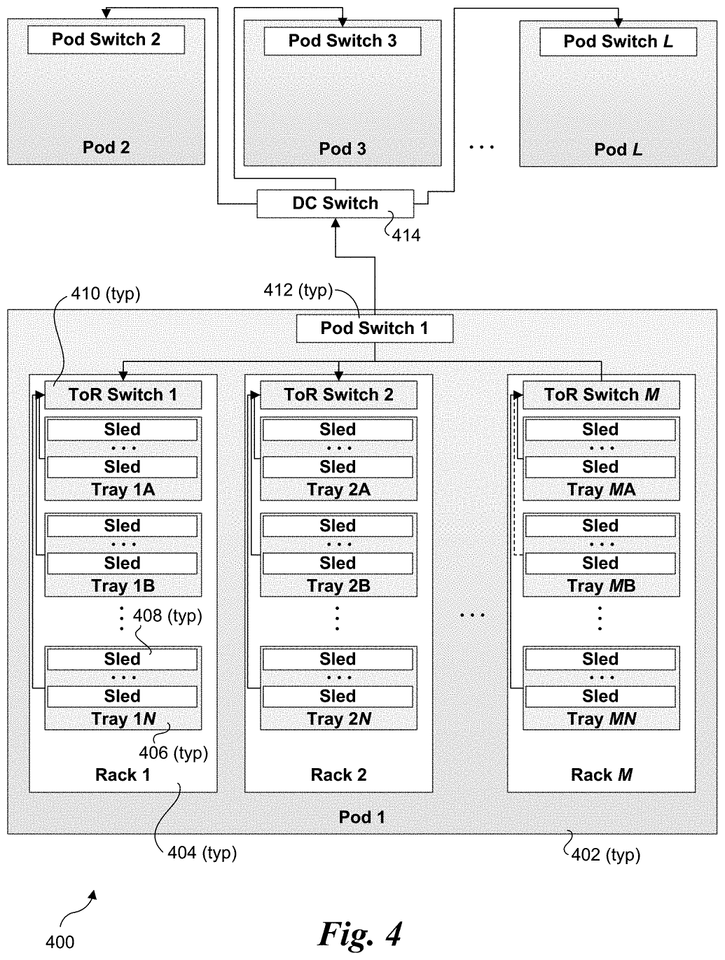

As further shown in FIG. 1, sub-management nodes 104-1 and 104-2 include redundant connections to each of racks 144 and 146, as depicted by communication links 154, 156, 158, and 160. In one embodiment, communication links 154, 156, 158 and 160 are implemented as in-band links. For example, as shown below in FIG. 4, under one rack architecture ToR switches are connected to POD switches, and there may be multiple links between a ToR switch and a POD switch to support data traffic; these links may be considered in-band links, and when telemetry and other data are collected via these communication links they are considered to use in-band communication. In some embodiments, separate traffic classes are used for management and/or control traffic. It is also common for separate links or channels to be used for management and/or control purposes, wherein the separate links and/or channels are not used to carry data traffic; such links and channel are considered out-of-band (OOB). In some cases, in-band and out-of-band links may employ different protocols and/or physical structures. In addition, rack architectures employing switch fabrics may also be implemented.

Internally, the software components in sub-management nodes 104-1 and 104-2 are connected to one another via virtual links depicted using lines with a dash-dot-dash format. The software components are interconnected with virtual links to form two stacks of three components: a sensys-ng module, a UAS broker, and a UAS metrics unit. For example, the stack on the left includes sensys-ng module 122, UAS broker 126, and UAS metrics unit 130. Software components in these two stacks are also cross-connected to software components in adjacent layers. For example, UAS metrics unit 130 is cross-connected to redundant UAS broker 128, while UAS metrics unit 132 is cross-connected to UAS broker 126. Similarly, sensys-ng module 122 is cross-connected to redundant UAS broker 128, while redundant sensys-ng module 124 is cross-connected to UAS broker 126.

The connections between a software component and a port is shown using thin lines. For example, each of sensys-ng modules 122 and 124 are connected to port 136. Connections between software components and ports may generally be implemented as a combination of a software-based (virtual) link and a physical link. For example, the ports may be ports in a network interface or network interface controller (NIC) that is coupled to a processor or CPU via a PCIe (Peripheral Component Interconnect Express) link. Moreover, transfers over these links may employ direct memory access (DMA) transactions. A DMA transaction effects of transfer between memory on separate devices over a physical link, such as a PCIe link.

The various interconnected software components and ports may be configured to implement multiple redundant channels. For example, software components in the three sub-layers may be interconnected to form up to six channels. This channel redundancy enables software components to fail while maintaining management operations and/or collection services, such as collection of telemetry data from the service nodes. For example, if a software component at a given sub-layer fails, the other instance of the software component (that is still running) may be employed. In general, the virtual links used to form software components stacks will be used when all software components are operating normally, with the cross-connected virtual links used for failovers.

Selected Software Component Details

Sensys-ng is a cluster monitoring system architected for exascale systems that provides resilient and scalable monitoring for resource utilization and node state of health, collecting data in a database for subsequent analysis. Sensys is an open-source project with code available on GitHub at https://github.com/intel-ctrlsys/sensys; Sensys-ng includes extensions to Sensys to support the functionality described herein. Sensys-ng includes several loadable plugins that monitor various metrics related to different features present in each node, such as temperature, voltage, power usage, memory, disk and process information. Sensys-ng modules 122, 123, 124, and 124 are instantiations of sensys-ng and comprise telemetry monitors that are configured to collect various telemetry data. Sensys-ng is a collector of metrics from the system (via UAS), and uses its features for solving different needs on the monitoring of these machines, including: aggregate the data over time windows, storing collected data in different databases, and working along with the UCS stack in order to fire RAS events. The sensys-ng modules herein provide extended functionality to support resiliency and redundancy, as described in further detail below.

Sensys-ng is responsible for providing resiliency to an HPC or exascale system. In one embodiment sensys-ng comprises two different variants of the service. The manager instance oversees monitoring the worker instances running on service nodes and assigns data collection jobs to each of the worker instances. Once the job is completed by the workers in the service nodes, assigned UAS brokers 126, 127, 128, and 129 collect the results in sub-management nodes 104-1 and 104-2. Sensys-ng modules 122 and 124 will collect the computed results from UAS brokers 122, 123, 124, and 124 and apply voting mechanism techniques to compare the computed results the receive. If any of the nodes indicate any difference in results (for example, this might happen due to communication failures or power off the physical node or various types of attacks), the redundant node will continue to operate, and the data will be retrieved from that node.

Actsys-ng is a unified tool that allows users to execute administrative and operational commands on clusters and supercomputers (e.g., HPC and exascale systems). Actsys is an open-source project with documentation at https://actsys.readthedocs.io/en/latest/; Actsys-ng includes extensions to Actsys to support the functionality described herein. Actsys-ng module 108 is an instantiation of the actsys-ng tool that is configured to organize hardware access into control actions. It coordinates orchestration of data collection with other components, including the sensys-ng modules illustrated in the figures herein. Actsys-ng includes a command interface, power commands, BIOS commands, OOB sensor commands, and can be configured for executing many other commands at scale by passing write operations to UAS.

Each UAS metrics unit 130, 131, 132, and 133, implements a UAS service that enables the hardware of the system to be queried and controlled. In one aspect, UAS is an abstraction service to the hardware similar to the device drivers layer of the Linux kernel; however, in UAS the services run in user-space instead of kernel-space, depending on user-space libraries for the interaction with the underlying components (e.g., FreeIPMI, NetSNMP, etc.). In one embodiment a UAS plugin is implemented in the service nodes for in-band service. If a collection for parameters exceeds some timeout, the UAS plugin may be disabled and reinitialized to enable using a larger wait times for each entry. For example: if the timeout is configured for 1 minute, the reinitialization may be tried after 1, 2, 5, 10, 15, 30 and 60 minutes.

A UAS broker is the manager of a UAS metrics unit (or under the embodiment of FIG. 1, two UAS metrics units. The UAS metrics units collect metrics from the service nodes, with those metrics being accessed by an instance of a UAS broker that operates as an interface between a sensys-ng or actsys-ng module and the UAS metrics units.

To optimize the UCS architecture and make the system available under hardware and software failures and continue to operate successfully, the embodiments herein propose a novel methodology by applying resiliency/redundancy and autonomic computing to the system layers. Specifically, resiliency is applied to the management/service node and sub-management nodes.

As depicted in FIG. 1, resiliency is applied in sub-management nodes 104-1 and 104-2 at all three sub-layers: sensys-ng, UAS broker, and UAS. Applying resiliency/redundancy to sensys-ng in the sub-management nodes enables recovery from failures or slowness in retrieving the data from the service nodes. Such failures may include hardware and software failure. Non-limiting examples of failures include software bugs; random hardware faults; memory bit “stuck”; and omission or commission fault in data transfer just to name a few. The redundant instances of sensys-ng collect data from the service nodes in parallel. The data collected by the sensys-ng instances (e.g., modules) are then compared and a voting mechanism is implemented to identify any failures.

Employing redundant UAS brokers in the sub-management nodes supports recovery from failures in the UAS metrics units and sensys-ng modules (e.g., software bugs, hardware bug preventing sensys-ng modules from collecting data, etc.). As shown in FIG. 1, sensys-ng module 122 is connected to UAS brokers 126 and 128, while redundant sensys-ng module 124 is also connected to UAS brokers 126 and 128. Thus, if one of UAS brokers 126 and 128 fails, its redundant “UAS Broker R” will still be able to collect metrics and system information from both UAS metrics units to which it is collected, and provide service back to the end user.

Another aspect of UAS architecture 100 is hardware redundancy and associated hardware resiliency. As discussed above, each of sub-management nodes 104-1 and 104-2 are connected to racks 144 and racks 146. As a result, if either of sub-management nodes 104-1 or 104-2 has a hardware failure, the other sub-management node can takeover. In addition, it is possible to have a hardware failure in a sub-management node that prevents one or more software components from operating while other software components including at least one software component at each sub-layer remain operational. In this case, the virtual interfaces that connected to the virtual links are reconfigured to not use the non-operating software components. For example, such hardware failures might include a failure of a network port, a failure in a processor core, a failure or inadvertent removal of a network cable, etc.

FIG. 1a shows a UCS architecture 100a illustrating a scalable aspect that may be implemented in deployments of the UCS architectures described and illustrated herein. In this example, there are N sub-management nodes of which four (sub-management nodes 104-1, 104-2, 104-3, and 104-4) are shown with the ellipses “ . . . ” representing the remaining instances of sub-management nodes. Each of sub-management nodes 104-1, 104-2, 104-3, and 104-4 and management/service node 102 is connected to switch 143, which is representative of one or more levels of switches. Sub-management nodes 104-1 and 104-2 are connected (through redundant links) to racks 144 and 146, while sub-management node 104-3 and 104-4 are connected (through redundant links) to racks 147 and 149. The other sub-management nodes would be connected to pairs of racks using redundant links in a similar manner. As further illustrated by ellipses, UCS architecture 100a may include one or more instances of management/service node 102.

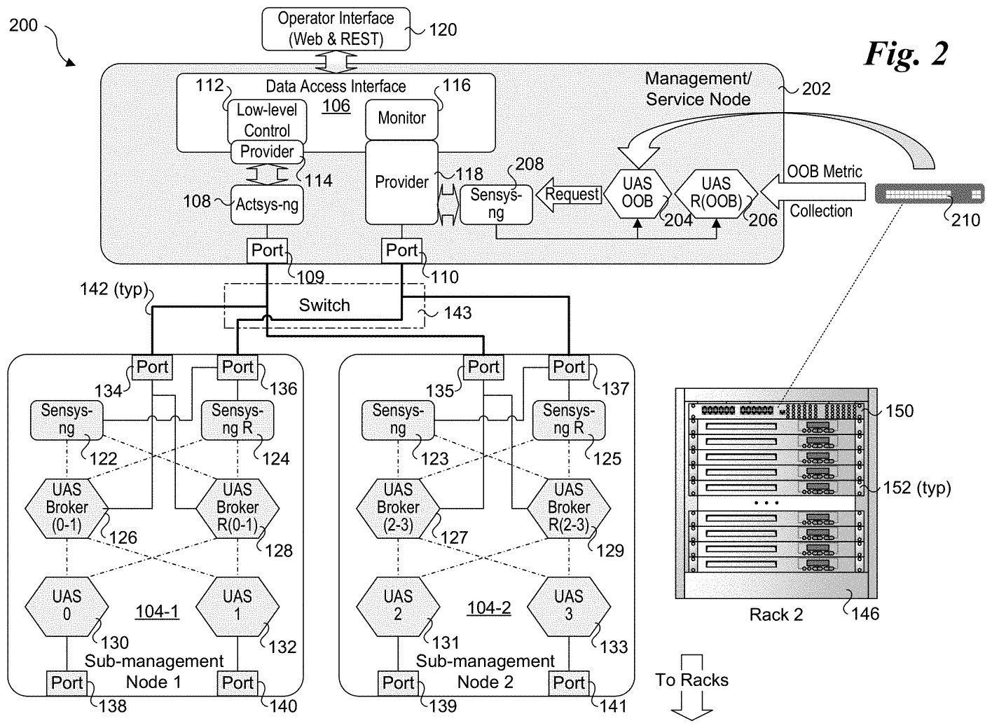

FIG. 2 shows a UCS architecture 200 in which further resiliency is implemented in a management/service node 202. In the illustrated embodiment, an out-of-band UAS metrics unit 204 and a redundant OOB UAS metrics unit 206 are added, each of which is connected to a sensys-ng module 208 via an OOB link or channel. A switch 210 is illustrative of a ToR switch or separate switch to which each of OOB UAS metrics units 202 and 204 is connected via an out-of-band link or channel; in practice, multiple instances of switch 210 would be implemented. In the illustrated example, switch 210 corresponds to ToR switch 150 in rack 146. Thus, OOB UAS metrics units 202 and 204 are used to collect metrics and system information from service nodes 152 in rack 146.

Using the resiliency approach at the management/service node layer enables recover from failures, faults or slowness in retrieving the computations by the sensys-ng module in the management/service node (e.g., management/service node 202). After the UAS OOB metrics are generated for the system, sensys-ng module 208 collects the results and applies the voting mechanism techniques between OOB UAS metrics units 204 and 206. Accordingly, even when UAS metrics do not get generated due to slowness in retrieving data or hardware failures, there will be at least one UAS metrics unit (whether in-band or 00B) that will continue to operate successfully and thus provide applicable UAS metrics and/or system information.

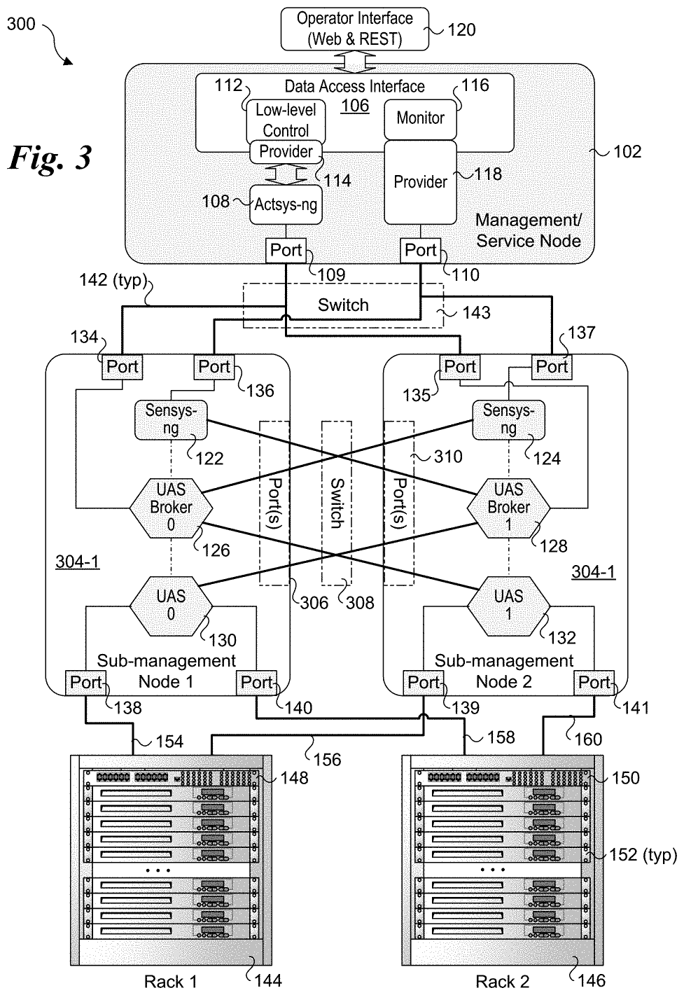

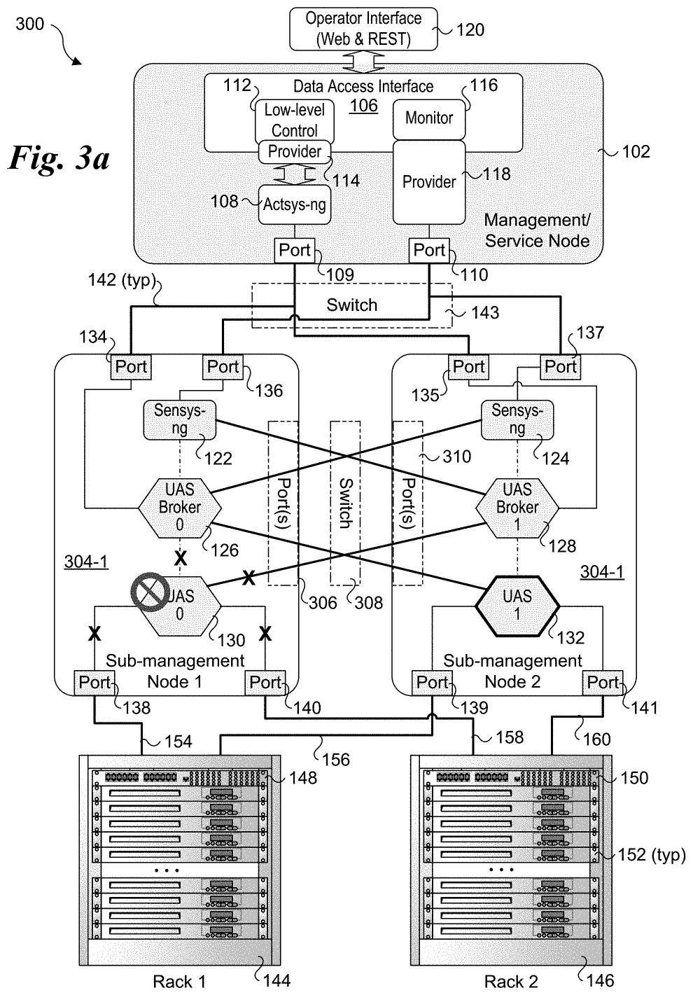

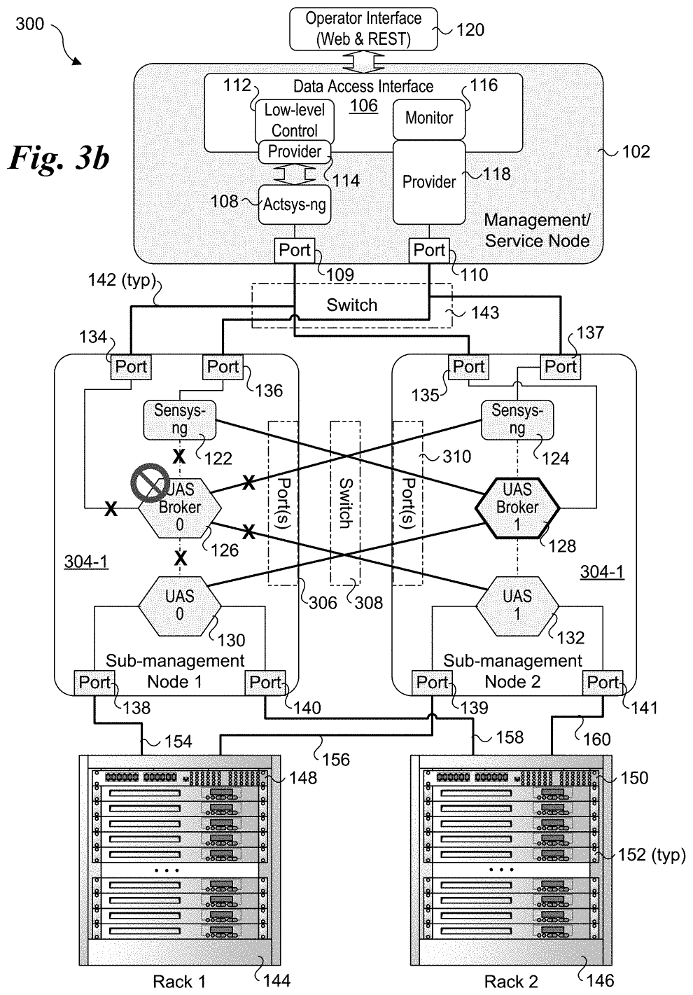

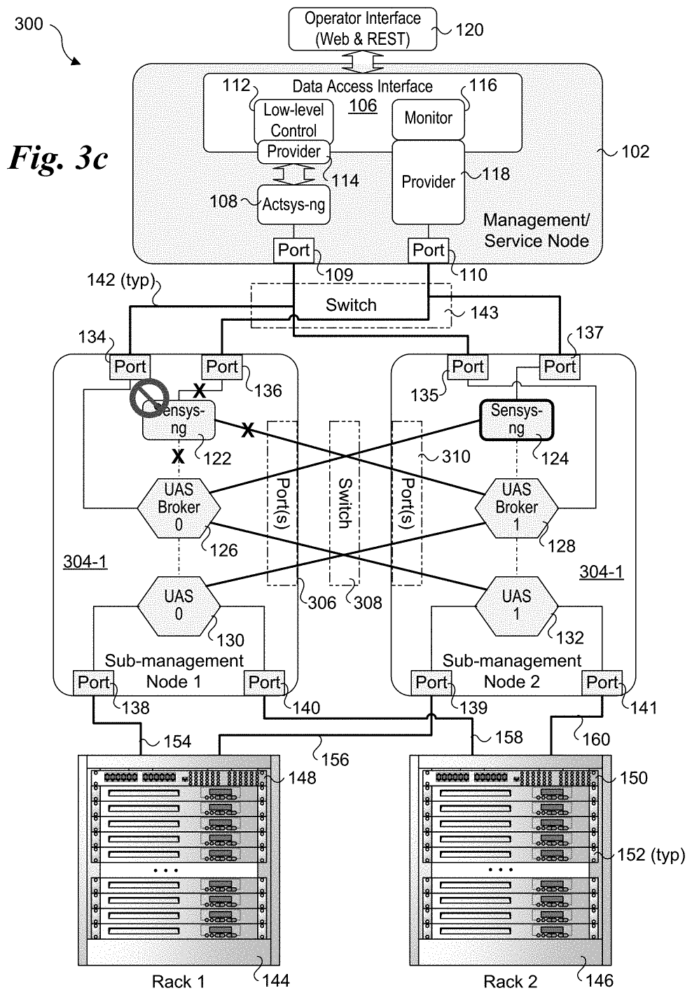

FIG. 3 shows a UCS architecture 300 in which sub-management nodes 304-1 and 304-2 are implemented in place of sub-management nodes 104-1 and 104-2 in FIGS. 1 and 2. Sub-management node 304-1 includes a sensys-ng module 122, a UAS broker 126 and a UAS metrics unit 130 that are interconnected by virtual links to form a first stack. Sub-management node 304-2 includes a sensys-ng module 124, a UAS broker 128 and a UAS metrics unit 132 that are interconnected by virtual links to form a second stack.

The software components in these stacks are cross-connected to software components in adjacent sub-layers in a manner similar to that discussed above for FIG. 1, except in this case the cross-connections are between separate physical machines (e.g., respective service nodes implemented for sub-management nodes 304-1 and 304-2). For simplicity and clarity the cross-connections are shown as bold lines directly coupled between the software components; in practice, the actual connection path will traverse one or more ports 306 in sub-management node 304-1, a switch 308, and one or more ports 310 in sub-management node 304-2, all of which are shown with phantom outline to show these ports and switch do not physically exist in the shown locations. Rather, ports 306 represent one or more of ports 134, 136, 138 and 140 on sub-management node 304-1, while ports 310 represent one or more of ports 135, 137, 139, and 141 on sub-management node 304-2. Meanwhile, switch 308 is representative of one or more switches, such as a ToR switch or a combination of a first ToR switch, a Pod switch, and a second ToR switch.

Another difference between UCS architecture 300 and UCS architectures 100 and 200 is the UAS metrics units are connected to two ports and collect telemetry data from service nodes in two racks. For example, UAS metrics unit 130 is connected to port 138, which is connected to ToR switch 148 in rack 144 via link 154. UAS metrics unit 130 is also connected to port 140, which is connected to ToR switch 150 in rack 146. UAS metrics unit 132 is likewise connected to racks 144 and 146 via connections to ToR switches 148 and 150.

USC architecture 300 also provides software component and hardware redundancy to support service resiliency. For example, consider a UAS metrics unit 130 fails, as shown in FIG. 3a. In this case, all the physical and virtual links going into and out of UAS metrics unit 130 would be disabled, as depicted by an “X”. UAS metrics unit 132 would be used as the UAS metric unit for the service nodes in both of racks 144 and 146.

In FIG. 3b, UAS broker 126 has failed. Thus, all the physical and virtual links going into and out of UAS broker 126 would be disabled, as depicted by an “X”, and UAS broker 128 would be used as the UAS broker for interfacing with both UAS metrics unit 130 and UAS metrics unit 132. In FIG. 3c, sensys-ng module 122 has failed, resulting in all the physical and virtual links going into and out of sensys-ng module 122 being disabled, as depicted by an “X”. Sensys-ng module 124 would be used as the sensys-ng module for the service nodes in both of racks 144 and 146 and collect telemetry data from UAS brokers 126 and 128.

In the event of a hardware failure that would disable the operation of either sub-management node 304-1 or 304-2, the remaining sub-management node would take over the sub-management node functions for the service nodes in both of racks 144 and 146. In one embodiment, the loss of a sub-management node is detected by actsys-ng 108 by detecting the loss of connectivity with port 134 or 135 (or otherwise lack of input data from one of the sub-management nodes). Alternatively, provider 118 or monitor 116 may detect the failure of a sub-management node by detecting the loss of connectivity with port 136 and 137 and/or loss of input data from one of the sub-management nodes.

As discussed above, an HPC or exascale system may employ various system architectures (i.e., physical arrangement of racks and servers). For example, some embodiments may employ a physical hierarchy of compute, network and shared storage resources to support scale out of workload requirements. FIG. 4 shows a portion of an exemplary physical hierarchy in a data center 400 including a number L of pods 402, a number M of racks 404, each of which includes slots for a number N of trays 406. Each tray 406, in turn, may include multiple sleds 408. For convenience of explanation, each of pods 402, racks 404, and trays 406 is labeled with a corresponding identifier, such as Pod 1, Rack 2, Tray 1B, etc. Trays may also be referred to as drawers, and sleds may also have various forms, such as modules and nodes. In addition to tray and sled configurations, racks may be provisioned using chassis in which various forms of servers are installed, such as blade server chassis and server blades or server modules.

Depicted at the top of each rack 404 is a respective top of rack (ToR) switch 410, which is also labeled by ToR Switch number. Generally, ToR switches 410 are representative of both ToR switches and any other switching facilities that support switching between racks 404. As mentioned above, it is conventional practice to refer to these switches as ToR switches whether they are physically located at the top of a rack (although they generally are).

Each Pod 402 further includes a pod switch 412 to which the pod's ToR switches 410 are coupled. In turn, pod switches 412 are coupled to a data center (DC) switch 414. The data center switches may sit at the top of the data center switch hierarchy, or there may be one or more additional layers that are not shown. For ease of explanation, the hierarchies described herein are physical hierarchies that use physical LANs. In practice, it is common to deploy virtual LANs using underlying physical LAN switching facilities.

In one embodiment of an exascale architecture, each of multiple cabinets includes a mix of compute blades (comprising compute nodes) and switch blades. The cabinet management includes the sub management nodes, which are connected to the ToR switch via a management aggregation switch that connects to TOR switch.

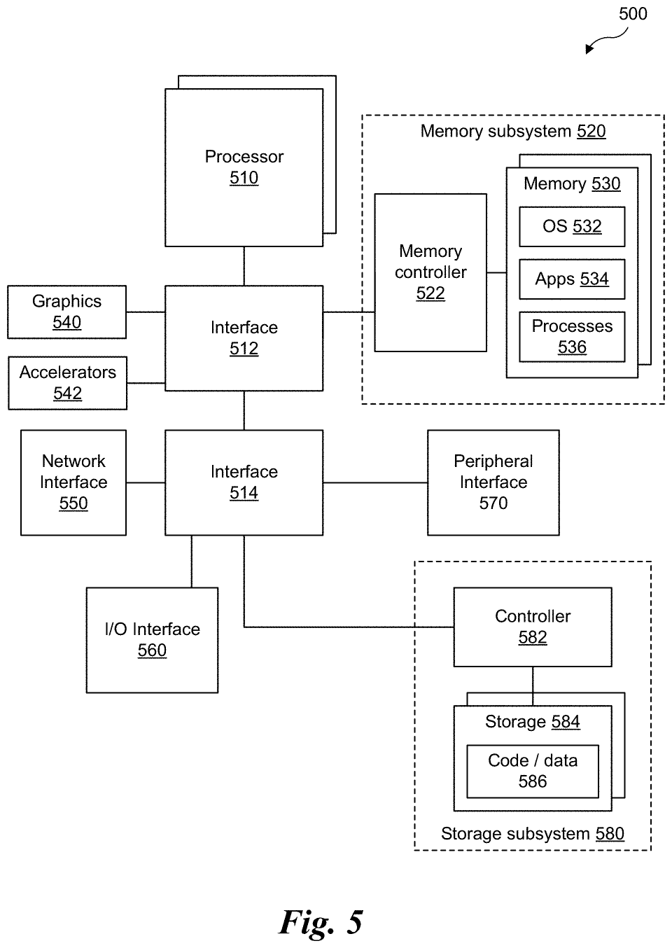

FIG. 5 depicts a system 500 that may be used for the service nodes herein. System 500 includes one or more processors 510, which provides processing, operation management, and execution of instructions for system 500. Processor 510 can include any type of microprocessor, central processing unit (CPU), graphics processing unit (GPU), processing core, multi-core processor or other processing hardware to provide processing for system 500, or a combination of processors. Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 500 includes interface 512 coupled to processor 510, which can represent a higher speed interface or a high throughput interface for system components that needs higher bandwidth connections, such as memory subsystem 520 or optional graphics interface components 540, or optional accelerators 542. Interface 512 represents an interface circuit, which can be a standalone component or integrated onto a processor die. Where present, graphics interface 540 interfaces to graphics components for providing a visual display to a user of system 500. In one example, graphics interface 540 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 540 generates a display based on data stored in memory 530 or based on operations executed by processor 510 or both. In one example, graphics interface 540 generates a display based on data stored in memory 530 or based on operations executed by processor 510 or both.

Accelerators 542 can be a fixed function offload engine that can be accessed or used by a processor 510. For example, an accelerator among accelerators 542 can provide compression (DC) capability, cryptography services such as public key encryption (PKE), cipher, hash/authentication capabilities, decryption, or other capabilities or services. In some embodiments, in addition or alternatively, an accelerator among accelerators 542 provides field select controller capabilities as described herein. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 542 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory. Network interface 550 can receive data from a remote device, which can include storing received data into memory. Various embodiments can be used in connection with network interface 550, processor 510, and memory subsystem 520.

In one example, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (i.e., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (i.e., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory is memory whose state (and therefore the data stored in it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 500. More specifically, power source typically interfaces to one or multiple power supplies in system 500 to provide power to the components of system 500. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 500 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Italicized letters, such as ‘n’, ‘N’, etc. in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules and components, firmware, and/or distributed software executed upon some form of processor, processing core or embedded logic a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

The operations and functions performed by various components described herein may be implemented by software running on a processing element, via embedded hardware or the like, or any combination of hardware and software. Such components may be implemented as software modules or components, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method of effecting fault tolerance for a high-performance computing (HPC) system employing a plurality of service nodes in a plurality of racks having switches to which the plurality of service nodes are communicatively-coupled, comprising:
implementing one or more management/service nodes in a management/service node layer;
implementing a plurality of sub-management nodes in a sub-management node layer;
for a sub-management node,
implementing a plurality of redundant software components in a plurality of sub-layers;
interconnecting software components in adjacent sub-layers to form one or more vertical stacks and one or more cross-connected stacks providing multiple redundant channels; and
connecting the sub-management node to switches in at least two racks,
wherein the sub-management nodes are configured to employ the multiple redundant channels to collect telemetry data from the plurality of service nodes in the plurality of racks such that the system continues to collect telemetry data in the event of a failure in a software component or a failure in hardware on a sub-management node.

2. The method of claim 1, wherein the plurality of sub-layers in a sub-management node include a top sub-layer comprising a redundant pair of telemetry collection modules.

3. The method of claim 2, wherein the plurality of sub-layers includes a bottom layer comprising at a redundant pair of sensor modules configured to query and control hardware in service nodes.

4. The method of claim 3, wherein the plurality of sub-layers include a middle sub-layer in which a redundant pair of brokers are implemented, wherein each broker is connected to a pair of sensor modules in the bottom layer and at least one telemetry collection module in the top sub-layer layer.

5. The method of claim 3, wherein the sensor modules comprise unified actor and sensor (UAS) service modules that are configured to communicate with UAS plugins running on service nodes.

6. The method of claim 1, further comprising implementing a voting mechanism to identify software component failures and hardware failures.

7. The method of claim 1, further comprising:
implementing an out-of-band (OOB) communication mechanism between switches in the plurality of racks and the one or more management/service nodes, the OOB communication mechanism including redundant OOB sensor modules configured to collect at least one of telemetry data and system information from the plurality of service nodes.

8. The method of claim 7, wherein the redundant OOB sensor modules comprise unified actor and sensor (UAS) service modules that are configured to communicate with UAS plugins running on service nodes.

9. The method of claim 1, further comprising implementing the plurality of sub-management nodes on a pairwise basis, wherein a pair of sub-management nodes is connected to a pair of racks.

10. A high-performance computing (HPC) system, comprising:
a plurality of racks, each comprising at least one switch coupled in communication with a plurality of service nodes;
a plurality of sub-management nodes comprising multiple sub-layers of stacked and cross-connected redundant software components providing multiple redundant channels, each sub-management node communicatively coupled to switches in multiple racks via multiple links; and
one or more management/service nodes communicatively connected to multiple sub-management nodes via a plurality of links,
wherein the sub-management nodes are configured to employ the multiple redundant channels to collect telemetry data from the plurality of service nodes such that the HPC system continues to collect telemetry data from the plurality of service nodes in the event of a failure in a software component or hardware failure on a sub-management node.

11. The HPC system of claim 10, wherein the plurality of sub-layers in a sub-management node include a top sub-layer comprising a redundant pair of telemetry collection modules and a bottom layer comprising a redundant pair of sensor modules configured to query and control hardware in service nodes.

12. The HPC system of claim 11, wherein the plurality of sub-layers include a middle sub-layer in which a redundant pair of brokers are implemented, wherein each broker is connected to a pair of sensor modules in the bottom layer and at least one telemetry collection module in the top layer.

13. The HPC system of claim 11, wherein the sensor modules comprise unified actor and sensor (UAS) service modules that are configured to communicate with UAS plugins running on service nodes.

14. The HPC system of claim 10, wherein the system further employs an out-of-band (OOB) communication mechanism between switches in the plurality of racks and the management/service node, the OOB communication mechanism including redundant OOB sensor modules configured to collect at least one of telemetry data and system information from the plurality of service nodes.

15. The HPC system of claim 10, wherein the system is configured to implement a voting mechanism to detect hardware failures and failures of software components.

16. The HPC system of claim 10, wherein a management/service node comprises a data access interface coupled to a first module comprising a telemetry monitor and a second module to organize hardware access and control actions.

17. A non-transitory machine-readable medium have instructions stored thereon configured to be executed on a processor of a sub-management node in a high-performance computing (HPC) system including a plurality of service nodes installed in a plurality of racks having switches to which the plurality of service nodes are communicatively-coupled, the sub-management node including memory and at least one network interface having one or more ports,
wherein the instructions comprise a plurality of redundant software components configured to be implemented in a plurality of sub-layers when loaded into the memory, the plurality of redundant software components arranged in first and second stacks and being cross-connected via virtual links in different sub-layers to provide multiple redundant channels, wherein each redundant software component in a lowest sub-layer is virtually connected to one or more switches via the at least one network interface; and
wherein, upon execution of the instructions on the processor the multiple redundant channels are employed to collect telemetry data from the plurality of service nodes in racks having switches to which the redundant software components in the lowest sub-layer are virtually connected and continue to collect the telemetry data from the plurality of service nodes in the event of a failure in a software component.

18. The non-transitory machine-readable medium of claim 17, wherein the plurality of sub-layers include a top sub-layer comprising a redundant pair of telemetry collection modules and a bottom layer comprising a redundant pair of sensor modules configured to query and control hardware in service nodes.

19. The non-transitory machine-readable medium of claim 18, wherein the sensor modules comprise unified actor and sensor (UAS) service modules that are configured to communicate with UAS plugins running on service nodes.

20. The non-transitory machine-readable medium of claim 17, wherein the plurality of sub-layers include a middle sub-layer in which a redundant pair of brokers are implemented, wherein each broker is connected to two sensor modules in the bottom layer and two telemetry collection modules in the top layer.
